(19) United States
(12) Patent Application Publication
(10) Pub. No.: US 2014/0035428 A1
(43) Pub. Date: Feb. 6, 2014

(54) Stator of rotary electric machine, and manufacturing method therefor

(71) Applicants: Masahiro Yuya, Tokyo (JP); Daisuke Shijo, Tokyo (JP); Hiroyuki Akita, Tokyo (JP); Haruyuki Hasegawa, Tokyo (JP); Takenori Aomi, Tokyo (JP); Ryoko Komaki, Tokyo (JP)

(72) Inventors: Masahiro Yuya, Tokyo (JP); Daisuke Shijo, Tokyo (JP); Hiroyuki Akita, Tokyo (JP); Haruyuki Hasegawa, Tokyo (JP); Takenori Aomi, Tokyo (JP); Ryoko Komaki, Tokyo (JP)

(73) Assignee: MITSUBISHI ELECTRIC CORPORATION, Chiyoda-ku, Tokyo (JP)

(21) Appl. No.: 13/983,623

(22) PCT Filed: Feb. 25, 2011
(86) PCT No.: PCT/JP2011/054315

§ 371 Date: Oct. 1, 2013

(51) Int. Cl. H02K 3/34; H02K 15/10; H02K 1/08

(52) U.S. Cl. CPC H02K 3/345; H02K 1/08; H02K 15/10
USPC 310/215; 310/216.057; 29/596

(57) ABSTRACT

A stator of a rotary electric machine, in which an insulating capacity higher than or equal to an insulating capacity of a flat portion of a stator core can be maintained at edge portions of the stator core. The stator of the rotary electric machine includes a core-sheet laminate that is formed by laminating a plurality of core sheets made of metal plates; a coating film that is made of an insulating paint coated on a surface of the core-sheet laminate; a stator coil that is made of a conductive wire wound around the core-sheet laminate via the coating film; and bobbins made of an insulating material, which are inserted between the coating film and the stator coil and prevent the conductive wire of the stator coil from contacting the coating film that is coated on edge portions of the core-sheet laminate, or relieve pressure caused by the contact.

### BACKGROUND OF THE INVENTION

1. Technical Field

The present invention relates to a stator of a rotary electric machine, which includes a core-sheet laminate on which a coating film made of an insulating paint is coated, and a stator coil made of conductive wires which are wound around the core-sheet laminate, and relates to a manufacturing method for the stator of the rotary electric machine.

2. Background Art

In conventional stators which are components of a rotary electric machine, such as a motor, there is a stator in which an insulating paint is coated on a stator core in order to electrically insulate a portion between the stator core and conductive wound around the stator core (for example, refer to Patent Document 1). For the conventional stator of the rotary electric machine, as a method of coating an insulating paint on the stator core, there is a method such as an electrodeposition coating method, an electrostatic painting method, or a spray painting method. However, in any of the methods, a film thickness coated on edge portions of the stator core is thinner than a film thickness coated on a flat portion the stator core to be coated, and an insulation capacity of the edge portions of the stator core is insufficient, so that it is feared that a short-circuit trouble or the like for the stator coil is caused.

Therefore, in order to maintain an insulation capacity of edge portions of a stator core, a stator is suggested in which the insulation capacity of the edge portions of the stator core is maintained in such a way that, for example, a composition ratio of a paint in an electrodeposition coating process is regulated so as to decrease a hardening shrinkage, and a percentage of a thickness of a coating film for edge portions (hereinafter, refer to as an edge-cover ratio) with respect to a thickness of a coating film for a flat portion of the stator core is improved (for example, refer to Patent Document 2).

Moreover, a stator is suggested in which the above-described edge-cover ratio of a coating film of a stator core is increased so as to maintain an insulation capacity of edge portions of the stator core in such a way that, in a stator core composed of a core-sheet laminate on which a plurality of core sheets, cut out from a metal plate by a pressing device, are laminated, each of the edge portions is formed in a near circular shape by laminating a plurality of core sheets in a state where an edge portion on a surface at an upstream side in a pressing direction of a pressing device in edge portions on two sides of the core sheets, in other words, an edge portion on a surface, at which a burr caused by the pressing is not protruded, is used as an edge portion of the stator core (for example, refer to Patent Document 3).

### CONVENTIONAL ART DOCUMENT

### Patent Document

### [Patent Document 1]

Japanese Laid-Open Patent Publication No. 2001-231191

### [Patent Document 2]

Japanese Laid-Open Patent Publication No. 2003-264951

### [Patent Document 3]

Japanese Laid-Open Patent Publication No. H09-191614

### SUMMARY OF THE INVENTION

### Problems to be Solved by the Invention

However, as the conventional stators of the rotary electric machines described in Patent Document 2 and Patent Document 3, even when an edge-cover ratio of the stator core is improved by regulating a composition ratio of an insulating paint so as to decrease a hardening shrinkage, or by forming edge portions of the stator core in a near circular shape, it is difficult that a film thickness of a coating film on the edge portions of the stator core is nearly equal to a film thickness of a coating film on the flat portion of the stator core (edge-cover ratio=100%). Therefore, there has been a problem in that it is very difficult that an insulation capacity of the edge portions of the stator core is nearly equal to an insulation capacity of the flat portion of the stator core.

Moreover, there have been problems in that, when conductive wires are wound around a stator core on which an insulating film is coated, a tension of the conductive wires generated at a time of winding the conductive wires is operated as pressing force toward edge portions of the stator core, whereby a coating film on the edge portions is destroyed, and a sufficient film thickness cannot be maintained, and moreover, the coating film on the edge portions of the stator core is stripped by frictional force, between the conductive wires and the stator core, which is generated in accordance with a positioning deviation of the conductive wires on the stator core at a time of winding the conductive wires around the stator core, whereby a short-circuit fault of the stator coil is caused.

The present invention has been made to solve the above-described problems in conventional stators of rotary electric machines, and an object of the invention is to provide a stator of a rotary electric machine in which an insulation capacity, which is higher than or equal to an insulation capacity at a flat portion of a core-sheet laminate, can be maintained at edge portions of the core-sheet laminate, and to provide a manufacturing method for the stator of the rotary electric machine.

### Means for Solving Problems

The stator of a rotary electric machine of the present invention includes a core-sheet laminate that is formed by laminating a plurality of core sheets made of metal plates; a coating film that is made of an insulating paint coated on a surface of the core-sheet laminate; a stator coil that is made of a conductive wire wound around the core-sheet laminate via the coating film; and bobbins made of an insulating material, which are inserted between the coating film and the stator coil corresponding to only the predetermined part of the core-sheet laminate containing edge portions, and prevent the conductive wire of the stator coil from contacting to the coating film that is coated on edge portions of the core-sheet laminate, or relieve pressure caused by the contact.

Moreover, the stator of a rotary electric machine of the present invention includes a core-sheet laminate that is formed by laminating a plurality of core sheets made of metal plates; bobbins, made of an insulating material, which are mounted on the core-sheet laminate in a state where the bobbins correspond to only the predetermined part of the core-sheet laminate containing edge portions; a coating film, made of an insulating paint, which is coated on an outer surface, on which the bobbins are not mounted, of the core-sheet laminate, and on an outer surface of the bobbins; and a stator coil that is made of a conductive wire wound around the core-sheet laminate and the bobbins via the coating film.

The manufacturing method for a stator of a rotary electric machine of the present invention includes a step of manufacturing a core-sheet laminate 6 that is formed by laminating a plurality of core sheets made of metal plates; a step of forming a coating film by coating an insulating paint on a surface of the core-sheet laminate; a step of mounting bobbins made of an insulating material on a surface of the coating film that is coated on at least edge portions or portions neighboring the edge portions of the core-sheet laminate; and a step of mounting a stator coil by winding a conductive wire around the core-sheet laminate via the coating film and the bobbins, wherein the bobbins are mounted on the surface of the coating film in a state where the bobbins correspond to only the predetermined part of the core-sheet laminate containing edge portions.

Moreover, the manufacturing method for a stator of a rotary electric machine of the present invention includes a step of manufacturing a core-sheet laminate 6 that is formed by laminating a plurality of core sheets made of metal plates; a step of mounting bobbins made of an insulating material on the surface of the core-sheet laminate in a state where the bobbins correspond to only the predetermined part of the core-sheet laminate containing edge portions; a step of forming a coating film by coating an insulating paint on a surface of the core-sheet laminate and a surface of the bobbins; and a step of mounting a stator coil on the core-sheet laminate by winding a conductive wire around a surface of the coating film.

### Effects of the Invention

According to the stator of the rotary electric machine of the present invention includes bobbins made of an insulating material, which are inserted between the coating film and the stator coil and prevent the conductive wire of the stator coil from contacting to the coating film that is coated on edge portions of the core-sheet laminate, or relieve pressure caused by the contact, so that the conductive wire is not contacted to edge portions on which the coating film is thin, and an insulation capability, which is higher than or equal to an insulation capability of a flat portion, can be maintained.

According to the stator of the rotary electric machine of the present invention includes bobbins, made of an insulating material, which are mounted on the core-sheet laminate in a state where the bobbins correspond to at least the edge portions of the core-sheet laminate; a coating film, made of an insulating paint, which is coated on an outer surface, on which the bobbins are not mounted, of the core-sheet laminate, and on an outer surface of the bobbins; and a stator coil that is made of a conductive wire wound around the core-sheet laminate and the bobbins via the coating film, so that an insulation capability, which is higher than or equal to an insulation capability of a flat portion, can be maintained.

The manufacturing method for a stator of a rotary electric machine of the present invention includes a step of forming a coating film by coating an insulating paint on a surface of the core-sheet laminate; a step of mounting bobbins made of an insulating material on a surface of the coating film that is coated on at least edge portions or portions neighboring the edge portions of the core-sheet laminate; and a step of mounting a stator coil by winding a conductive wire around the core-sheet laminate via the coating film and the bobbins, so that it can be prevented that the coating film on the edge portions of the stator core is destroyed or stripped by frictional force, between the conductive wires and the stator core, which is generated in accordance with a positioning deviation of the conductive wires on the stator core at a time of winding the conductive wires around the core-sheet laminate, and it can be prevented that a short-circuit fault or the like is generated.

Moreover, the manufacturing method for a stator of a rotary electric machine of the present invention includes a step of mounting bobbins made of an insulating material on at least edge portions or portions neighboring the edge portions of the core-sheet laminate; a step of forming a coating film by coating an insulating paint on a surface of the core-sheet laminate and a surface of the bobbins; and a step of mounting a stator coil on the core-sheet laminate by winding a conductive wire around a surface of the coating film, so that it can be prevented that the coating film on the edge portions of the stator core is destroyed or stripped by frictional force, between the conductive wires and the stator core, which is generated in accordance with a positioning deviation of the conductive wires on the stator core at a time of winding the conductive wires around the core-sheet laminate, and it can be prevented that a short-circuit fault or the like is generated.

### BRIEF DESCRIPTION OF THE DRAWINGS

FIG. 1 is an oblique perspective view illustrating a stator magnetic pole in a stator of a rotary electric machine according to Embodiment 1 of the present invention;

FIGS. 2 are explanatory views illustrating a configuration of a stator core in the stator of the rotary electric machine according to Embodiment 1 of the present invention;

FIGS. 3 are explanatory views illustrating a configuration of the stator magnetic pole in the stator of the rotary electric machine according to Embodiment 1 of the present invention;

FIGS. 4 are explanatory views illustrating a manufacturing method for the stator of the rotary electric machine according to Embodiment 1 of the present invention;

FIGS. 5 are explanatory views illustrating a mounting method for a bobbin in the stator of the rotary electric machine according to Embodiment 1 of the present invention;

FIG. 6 is an oblique perspective view illustrating a stator magnetic pole in the stator of the rotary electric machine, as a deformation example, according to Embodiment 1 of the present invention;

FIG. 7 is an oblique perspective view illustrating a stator magnetic pole in a stator of a rotary electric machine according to Embodiment 2 of the present invention;

FIGS. 8 are explanatory views illustrating a configuration of a stator core in the stator of the rotary electric machine according to Embodiment 2 of the present invention;

FIGS. 9 are explanatory views illustrating a manufacturing method for the stator of the rotary electric machine according to Embodiment 2 of the present invention;

FIG. 10 is an oblique perspective view illustrating a core sheet in a stator of a rotary electric machine according to Embodiment 3 of the present invention;

FIG. 11 is an oblique perspective view illustrating a stator magnetic pole in the stator of the rotary electric machine according to Embodiment 3 of the present invention;

FIG. 12 is an oblique perspective view illustrating a core sheet in a stator of a rotary electric machine according to Embodiment 4 of the present invention; and

FIG. 13 is an oblique perspective view illustrating a stator magnetic pole in the stator of the rotary electric machine according to Embodiment 4 of the present invention.

### DETAILED DESCRIPTION OF THE PREFERRED EMBODIMENTS

### Embodiment 1

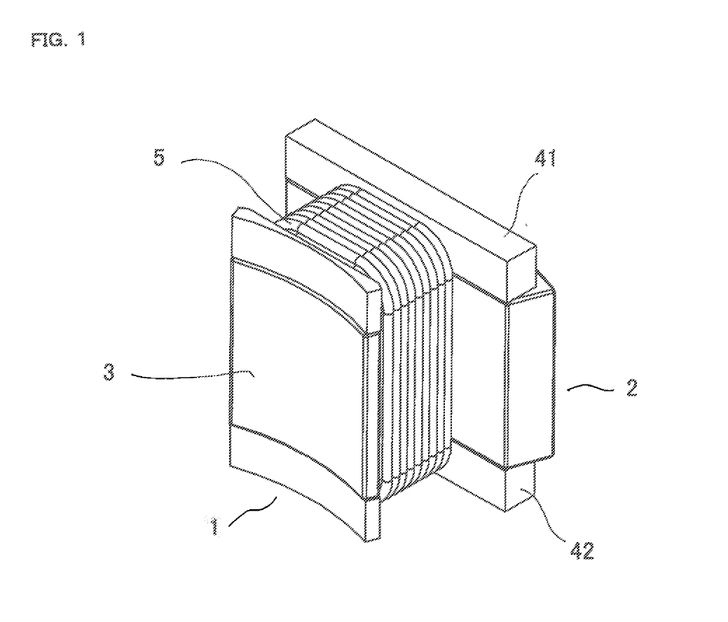

FIG. 1 is an oblique perspective view illustrating a stator magnetic pole in a stator of a rotary electric machine according to Embodiment 1 of the present invention. In FIG. 1, a stator magnetic pole 1 composing a rotary electric machine, such as a motor, includes a stator core 2 having a coating film 3, which is formed by coating an insulating paint on a surface of a core-sheet laminate that is formed by laminating a plurality of core sheets made of a metal; a first bobbin 41 made of an insulating material, which is mounted on one end surface formed as a first surface in a core-sheet-laminate direction of the stator core 2; and a second bobbin 42 made of an insulating material, which is mounted on the other end surface formed as a second surface in the core-sheet-laminate direction of the stator core 2; and a stator coil 5 that is configured by winding a conductive wire around the stator core 2 via the first bobbin 41 and the second bobbin 42. As illustrated in FIG. 1, the conductive wire composing the stator coil 5 is wound in such a way that the conductive wire roughly includes the stator core 2, the first bobbin 41, and the second bobbin 42, on which coating film 3 used as the insulating paint is coated.

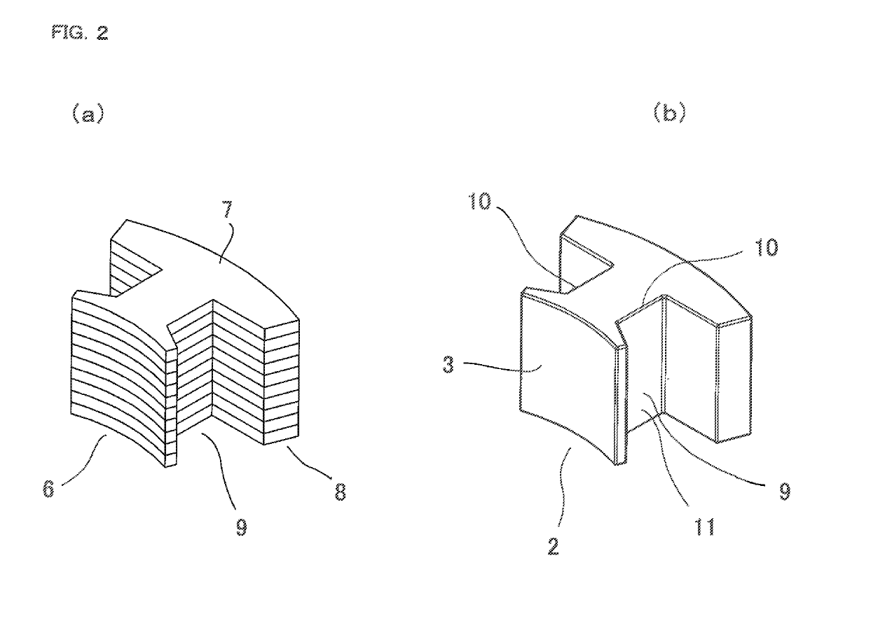

FIGS. 2 are explanatory views illustrating a configuration of a stator core in the stator of the rotary electric machine according to Embodiment 1 of the present invention. FIG. 2(a) is an oblique perspective view illustrating a core-sheet laminate at a time before a coating film is coated, and FIG. 2(b) is an oblique perspective view illustrating the stator core that is configured by coating the coating film on a surface of the core-sheet laminate. As illustrated in FIG. 2(a), a core-sheet laminate 6, at a time before a coating film is coated, is configured in such a way that ten core sheets 7 having a near T-shape, which are made of metal plates, are laminated, and the core sheets 7 are integrally fixed. The core sheets 7, which are made of metal plates, include a yoke portion 8 and a teeth portion 9 which is almost vertically protruded from the yoke portion 8 in a direction where a surface of the yoke portion 8 is extended. A coating film made of an insulating paint is coated on whole surface of the core-sheet laminate 6 illustrated in FIG. 2(a), whereby the stator core having the coating film 3 illustrated in FIG. 2(b) is configured. The outer surface of the stator core 2, which is configured as described above, includes edge portions 10 and a flat portion 11.

In addition, a number of laminated sheets of the core sheets 7, composing the core-sheet laminate 6, is not limited to ten, and the number can be freely determined in accordance with a specification or the like of the rotary electric machine.

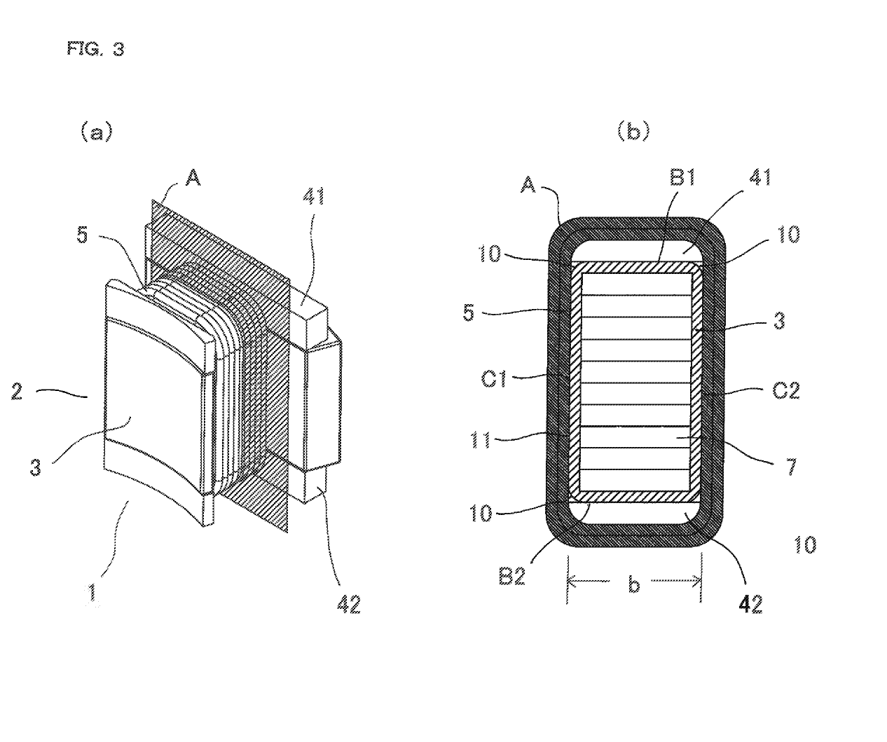

FIGS. 3 are explanatory views illustrating a configuration of the stator magnetic pole in the stator of the rotary electric machine according to Embodiment 1 of the present invention. FIG. 3(a) is an explanatory view in which a plain surface “A”, indicating a position of a cross-sectional surface, and the stator magnetic pole are indicated by an oblique perspective view, and FIG. 3(b) is an explanatory view indicating the cross-sectional surface at the plain surface “A” indicated in FIG. 3(a). In FIG. 3(a) and FIG. 3(b), the first bobbin 41 has a near T-shape being similar to the core sheets 7, and the first bobbin 41 is mounted on one end surface in a core-sheet-lamination direction of the stator core 2, on which the coating film 3 is coated. The second bobbin 42 has a near T-shape being similar to the core sheets 7, and the first bobbin 41 is mounted on one end surface in a direction of the laminated core sheet of the stator core 2, on which the coating film 3 is coated.

The stator coil 5 wound around the teeth portion 9 (refer to FIGS. 2) of the stator core 2 is contacted to an outer surface of the first bobbin 41 and the second bobbin 42 at coating surfaces B1 and B2 side of the stator core 2, and is contacted to an outer surface of the coating film 3 at coating surfaces C1 and C2 side of the stator core 2.

On the plain surface A illustrated in FIGS. 3, the stator magnetic pole is formed in such a that a width “b” of each of the first bobbin 41 and the second bobbin 42 is equal to a width of each of the coating surfaces B1 and B2. Therefore, the stator coil 5 is not contacted to the coating surfaces B1 and B2, and moreover, the stator coil 5 can be wound around the teeth portion of the stator core 2 without contacting to the four edge portions 10 of the stator core 2. In addition, the stator magnetic pole may be formed in such a way that the width b is longer than the width of each of the coating surfaces B1 and B2.

As described above, the stator coil 5 is not contacted to the edge portions 10 of the stator core 2, so that press power, according to a tension of conductive wires, toward the edge portions 10 is not generated, and the coating film 3 of the edge portions 10 is not destroyed. Moreover, friction between the conductive wires and the coating film 3, which is generated in accordance with a deviation of the conductive wires composing the stator coil 5, is not generated at the edge portions 10, so that the coating film 3 of the edge portions 10 is not stripped.

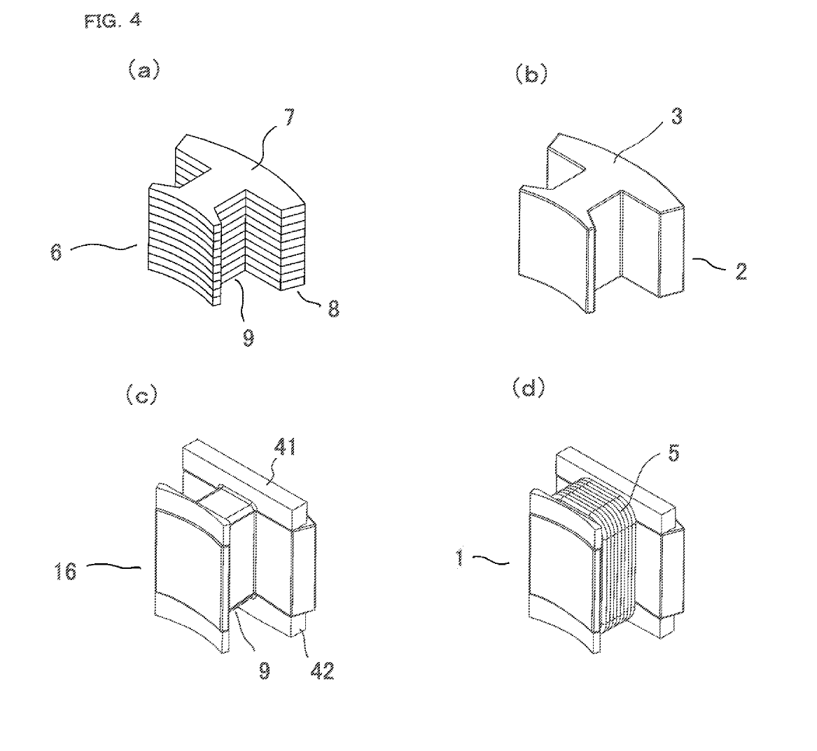

Hereinafter, a manufacturing method for the rotary electric machine according to Embodiment 1 will be explained. FIGS. 4 are explanatory views illustrating the manufacturing method for the stator of the rotary electric machine according to Embodiment 1 of the present invention. FIG. 4(a) indicates a lamination step in which the core-sheet laminate is manufactured by laminating the core sheets, and FIG. 4(b) indicates an insulation step in which a coating film is coated on the core-sheet laminate, and FIG. 4(c) indicates a bobbin attachment step in which a bobbin is attached to a stator core on which the coating film is coated, and FIG. 4(d) indicates a coil installation step in which conductive wires are wound around the stator core to which the bobbin is attached, and the stator coil is installed.

Firstly, a plurality of core sheets 7 made of metal plates is prepared. The core sheets 7 is formed in a near T-shape in which the yoke portion 8 and the teeth portion 9, which is almost vertically protruded from the yoke portion 8 in a direction where a surface of the yoke portion 8 is extended, are included. Although it is a general manufacturing method for the core sheets 7 that a metal object as a metal plate is cut out by a pressing device so as to be manufactured, the core sheets 7 may be manufactured from a metal object as a metal plate by using a wire-cutting method or a laser-cutting method. The core sheets 7 manufactured as described above are laminated in a thickness direction of the core sheets 7 as illustrated in FIG. 4(a). The laminated core sheets 7 are integrally fixed by swaging, bonding, or welding, whereby the core-sheet laminate 6 is formed.

Secondly, an insulation paint is painted on whole surface of the core-sheet laminate 6 formed as described above, whereby the stator core 2 illustrated in FIG. 4(b) is formed. An electrodeposition coating method, an electrostatic painting method, or a spray painting method is suggested as a method of painting the insulation paint on the surface of the core-sheet laminate 6. When the insulation paint is painted on the core-sheet laminate 6, the stator core 2 is obtained in a state where whole outer surface of the core-sheet laminate 6 is coated by the coating film 3.

Thirdly, as illustrated in FIG. 4(c), the first bobbin 41 having a near T-shape, which is made of an insulation object, is mounted on one end surface formed as a first surface in a core-sheet-laminate direction of the stator core 2 on which the coating film 3 is coated, and the second bobbin 42 is mounted on the other end surface formed as a second surface in the core-sheet-laminate direction of the stator core 2, whereby an exterior core 16 is produced. One end surface as a first surface and the other end surface as a second surface are used as two surfaces facing each other. A method of mounting the first bobbin 41 and the second bobbin 42 onto the stator core 2 is described later. Lastly, the stator coil 5 is mounted on the teeth portion 9 by winding the conductive wires around the teeth portion 9 of the exterior core 16. The first bobbin 41 and the second bobbin 42 prevent the conductive wires of the stator coil 5 from contacting to the coating film coated on the edge portions of the core-sheet laminate, or relieve pressure caused by the contact. Thereby, the manufacture of the stator magnetic pole 1 illustrated in FIG. 4(d) is completed.

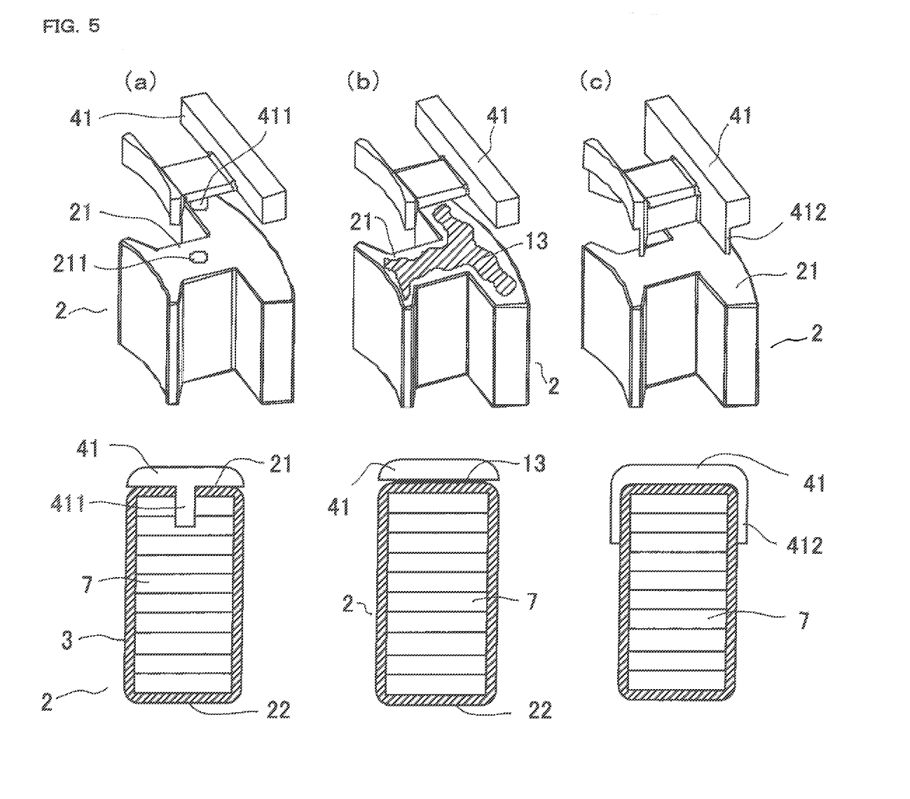

FIGS. 5 are explanatory views illustrating a mounting method for a bobbin in the stator of the rotary electric machine according to Embodiment 1 of the present invention. FIG. 5(a), FIG. 5(b), and FIG. 5(c) indicate mounting methods which are different each other. In the first bobbin 41 illustrated in FIG. 58a), a protrusion 411 is formed on a surface contacting one end surface 21 in a core-laminate direction, which is a first surface the stator core 2. Moreover, a hole 211 for inserting the protrusion 411 of the first bobbin 41 is formed on one end surface 21 formed as the first surface.

In the mounting method for the bobbin illustrated in FIG. 5(a), the first bobbin 41 is fixed and mounted onto one end surface 21 of the stator core 2 by inserting the protrusion 411 of the first bobbin 41 into a hole 211 of the stator core 2. The second bobbin 42 (not illustrated) is also fixed and mounted onto the other end surface 22 formed as a second surface. As a method of forming the hole 211 in the stator core 2, any of methods, such as a method of using a core sheet in which the hole 211 is already formed, a method of forming the hole 211 in a laminate on which a coating film is not coated yet, or a method of forming the hole 211 in a state where the stator core 2 is already formed by coating the coating film 3, may be used.

In the mounting method for the bobbin illustrated in FIG. 5(b), the first bobbin 41 is glued and mounted onto one end surface 21 of the stator core 2 by using an adhesive 13. The second bobbin 42 (not illustrated) is also glued and mounted onto the other end surface 22. The adhesive 13 may be painted on the bobbin side or the stator core 2 side, or painted on the both sides.

In the mounting method for the bobbin illustrated in FIG. 5(c), legs 412 are provided to the first bobbin 41, and the first bobbin 41 is formed in a state where a cross-sectional surface of the first bobbin 41 has a near “]”shape, and then, a part of side surface of one end surface 21 of the stator core 2 is sandwiched by the legs 412 of the first bobbin 41, whereby the first bobbin 41 is mounted on the one end surface 21 of the stator core 2. The second bobbin 42 (not illustrated) is similarly bonded and mounted onto the other end surface 22 of the stator core 2.

In addition, the first bobbin 41 and the second bobbin 42 may be respectively mounted on both side surfaces, facing each other, of the stator core 2, in other words, on two surfaces extended in the core-sheet-laminate direction of the stator core 2.

After the first bobbin 41 and the second bobbin 42 are mounted on the stator core 2 as described above, the stator coil 5 is mounted so as to configure the stator magnetic pole 1. A plurality of the stator magnetic poles 1 being configured as described above are arranged on a stator frame (not illustrated) having a cylindrical shape in a state where each of the stator magnetic poles 1 is separated with a predefined angle, whereby a stator of the rotary electric machine is configured.

As described above, in the rotary electric machine according to Embodiment 1 of the present invention, it can be realized that conductive wires are wound around the teeth portion 9 of the stator core 2, without contacting the conductive wires to the edge portions 10 of the stator core 2, and the stator coil 5 is formed so as to be mounted, so that it can be suppressed that the coating film 3 of each of the edge portions 10 is destroyed or stripped, and it can be reduced that an insulation fault , such as a short circuit fault, is generated. Moreover, it can be prevented that a coating failure, due to contact of the edge portions 10 with the conductive wires of the stator coil 5, is destroyed, and it can be expected that generation of an insulation fault, due to the conductive wires, is reduced.

Moreover, the conductive wires are wound so as to form the stator coil 5 in a state where the first bobbin 41 and the second bobbin 42 are mounted onto the stator core 2 on which coating film 3 is coated, so that an alignment capability of the stator coil 5 is improved, and the conductive wires can be wound in a higher density, and high efficiency of the stator can be expected.

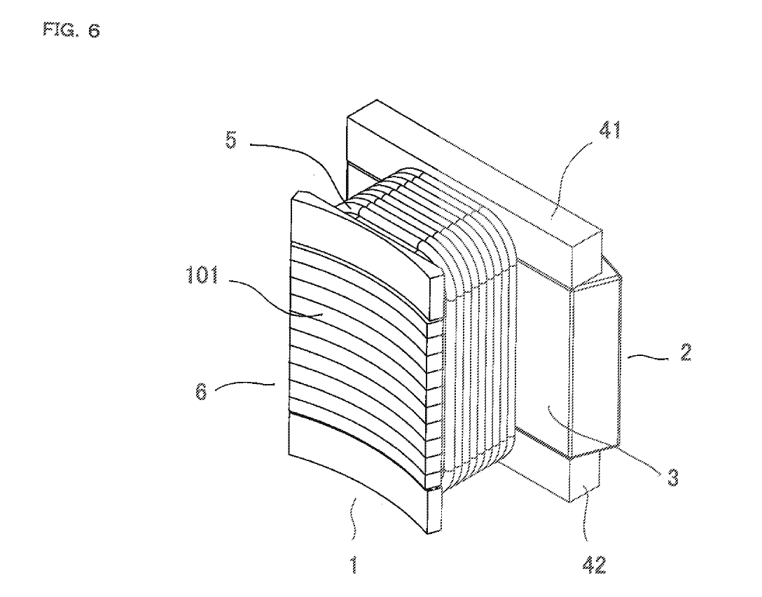

FIG. 6 is an oblique perspective view illustrating a stator magnetic pole in the stator of the rotary electric machine, as a deformation example, according to Embodiment 1 of the present invention. In the stator magnetic pole according to Embodiment 1 of the present invention, the stator core 2 is configured by coating the coating film 3 in such a way that the coating film 3 covers whole surface of the core-sheet laminate 6. However, as illustrated in FIG. 6, the core-sheet laminate 6 may be exposed without coating the coating film 3 on a portion, at which the conductive wires of the stator coil 5 are not directly contacted to the stator core 2, in other words, on a surface 101 facing an outer surface of a rotor (not illustrated) of the rotary electric machine.

### Embodiment 2

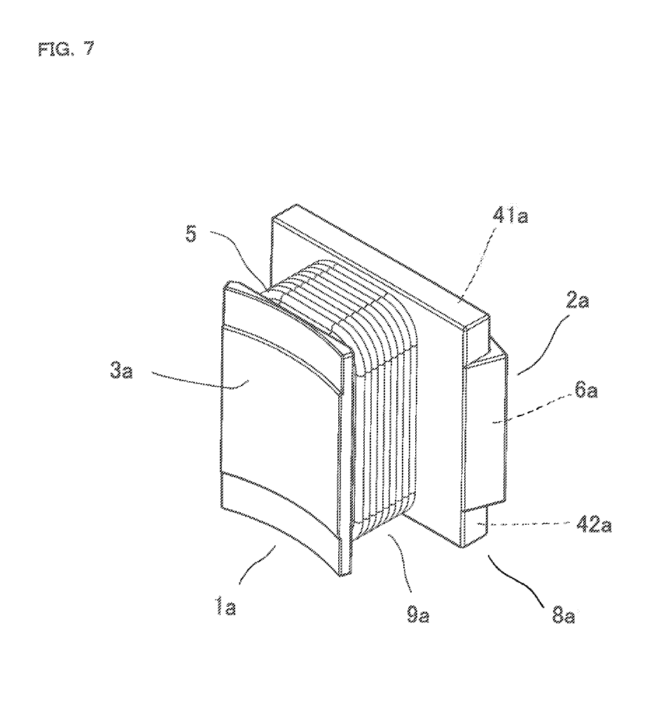

FIG. 7 is an oblique perspective view illustrating a stator magnetic pole in a stator of a rotary electric machine according to Embodiment 2 of the present invention. In FIG. 7, a stator magnetic pole 1a, which composes a stator of a rotary electric machine, such as a motor, includes a stator core 2a and a stator coil 5 in which conductive wires wound around a teeth portion 9a of the stator core 2a to be mounted. The stator core 2a is configured in such a way that a first bobbin 41a and a second bobbin 42a are respectively mounted on both end portions of a core-sheet laminate 6a, which is formed by laminating predefined number of core sheets, so as to be integrally configured, and then, an insulating paint is wholly painted on the integrated core-sheet laminate 6a, a first bobbin 41a, and a second bobbin 42a. The stator coil 5 is configured in such a way that the conductive wires are wound around the teeth portion 9a of the stator core 2a that is configured as described above.

In addition, the first bobbin 41a and the second bobbin 42a may be respectively on both side surfaces, which face each other, of the stator core 2a, in other words, on two surfaces extended in a core-sheet-laminate direction of the stator core 2a.

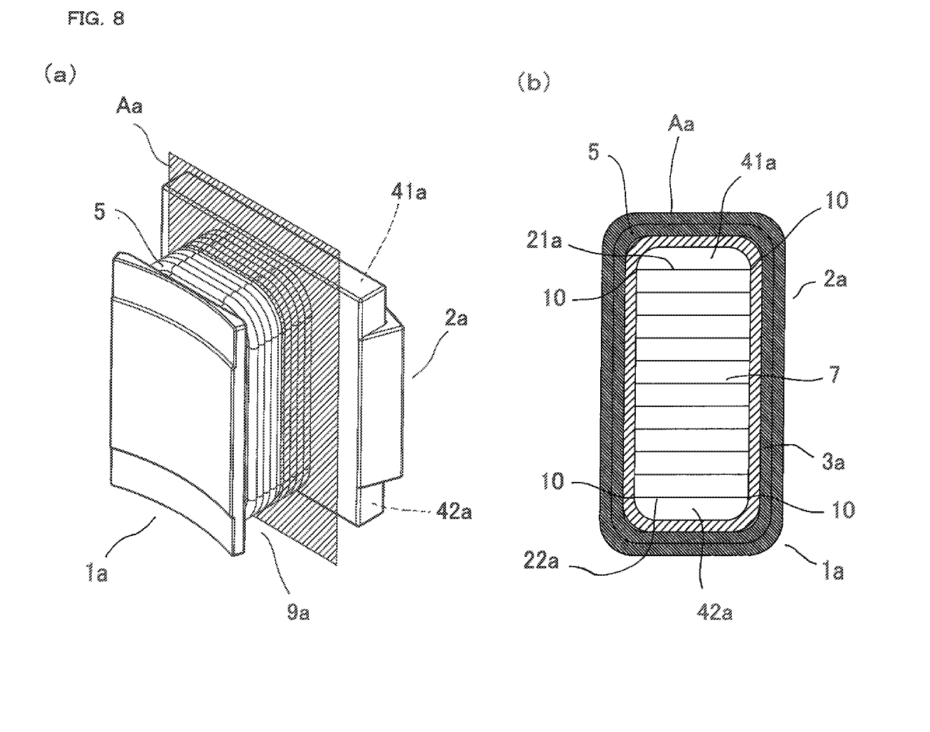

FIGS. 8 are explanatory views illustrating a configuration of a stator core in the stator of the rotary electric machine according to Embodiment 2 of the present invention. FIG. 8(a) is an explanatory view in which a plain surface “Aa”, indicating a position of a cross-sectional surface, and the stator magnetic pole are indicated by an oblique perspective view, and FIG. 8(b) is an explanatory view indicating the cross-sectional surface at the plain surface “Aa” indicated in FIG. 8A. In FIG. 8(a) and FIG. 8(b), the first bobbin 41a has a near T-shape being similar to the core sheets 7, and the first bobbin 41a is mounted on one end surface in a core-sheet-lamination direction of the stator core 2a, on which a coating film 3a is coated. The second bobbin 42a has a near T-shape being similar to the core sheets 7, and the first bobbin 41a is mounted on one end surface in a direction of the laminated core sheet of the stator core 2a, on which the coating film 3a is coated.

The stator coil 5, which is wound around the teeth portion 9a of the stator core 2a, is contacted to an outer surface of the coating film 3a that is coated on whole surfaces of the stator core 2a, the first bobbin 41a, and the second bobbin 42a. Thereby, the stator coil 5 is not contacted to four edge portions 10 of the core sheets 7, so that the coating film 3a is not destroyed.

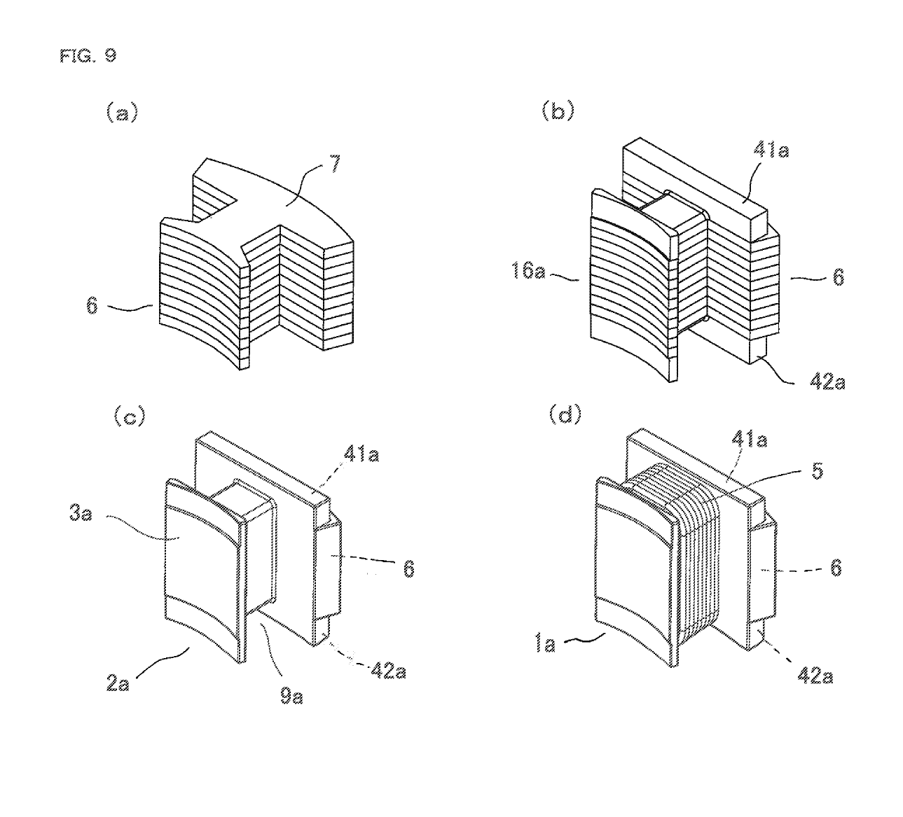

Hereinafter, a manufacturing method for the above-described stator of the rotary electric machine according to Embodiment 2 will be explained. FIGS. 9 are explanatory views illustrating a manufacturing method for the stator of the rotary electric machine according to Embodiment 2 of the present invention. FIG. 9(a) indicates a lamination step in which the core-sheet laminate is manufactured by laminating the core sheets, and FIG. 9(b) indicates a bobbin attachment step in which a bobbin is attached to the core-sheet laminate, and FIG. 9(c) indicates a painting step in which the stator core 2a is manufactured by coating the coating film 3a made of an insulating paint on the outer surface of the integrated component formed with the core-sheet laminate and the bobbin, and FIG. 9(d) indicates a coil installation step in which conductive wires are wound around the stator core 2a on which the coating film is coated.

A method of forming the core-sheet laminate 6a illustrated in FIG. 9(a) is similar to the above-described method indicated in FIG. 4(a) according to Embodiment 1, so that an explanation for the method is omitted. Next, as illustrated in FIG. 9(b), an integrated component 16a, which is formed with the core-sheet laminate and the bobbin, is formed by respectively mounting the first bobbin 41a and the second bobbin 42a, which are composed of an insulating component and have a near T-shape, on both end surfaces in a core-sheet-laminate direction of the core-sheet laminate 6a. A method of mounting the first bobbin 41a and the second bobbin 42a on the core-sheet laminate 6a is performed with the similar way in Embodiment 1 without a point of the method in which the first bobbin 41a and the second bobbin 42a are directly mounted without intervening a coating film. The insulation paint is painted on whole surfaces of the integrated component 16a composed of the core-sheet laminate 6a and the bobbins, which are formed as described above, whereby the stator core 2a illustrated in FIG. 9(c) is configured.

An electrodeposition coating method, an electrostatic painting method, or a spray painting method is suggested as a method of painting the insulation paint on whole surfaces of the integrated component 16a composed of the core-sheet laminate and the bobbins. The coating film 3a made from an insulating paint is coated on whole surfaces of the integrated component 16a composed of the core-sheet laminate and the bobbins, whereby the stator core 2a on which coating film 3a is coated. Lastly, the stator coil 5 is mounted on the teeth portion 9a by winding the conductive wires around the teeth portion 9c of the stator core 2a. Thereby, the manufacture of the stator magnetic pole la illustrated in FIG. 9D is completed.

A plurality of the stator magnetic poles 1a manufactured as described above are arranged on a stator frame (not illustrated) having a cylindrical shape in a state where each of the stator magnetic poles 1a is separated with a predefined angle, whereby a stator of the rotary electric machine is configured.

As described above, in the rotary electric machine according to Embodiment 2 of the present invention, it can be realized that conductive wires are wound around the teeth portion 9a of the stator core 2a, without contacting the conductive wires to the edge portions 10 of the stator core 2, and the stator coil 5 is formed so as to be mounted, so that it can be reduced that an insulation fault, such as a short circuit fault, of the stator coil 5 is generated.

Moreover, the conductive wires are wound so as to form the stator coil 5 in a state where the first bobbin 41a and the second bobbin 42a are mounted, so that an alignment capability of the stator coil 5 is improved, and the conductive wires can be wound in a higher density, and high efficiency of the stator can be expected.

In addition, in the stator magnetic pole according to Embodiment 2 of the present invention, the stator core 2a is configured by coating the coating film 3a in such a way that the coating film 3 covers whole surface of the core-sheet laminate 6a. However, in a similar way illustrated in FIG. 6 according to Embodiment 1, the core-sheet laminate 6a may be exposed without coating the coating film 3a on a portion, at which the conductive wires of the stator coil 5 are not directly contacted to the stator core 2a, in other words, on a surface 101 facing an outer surface of a rotor (not illustrated) of the rotary electric machine.

### Embodiment 3

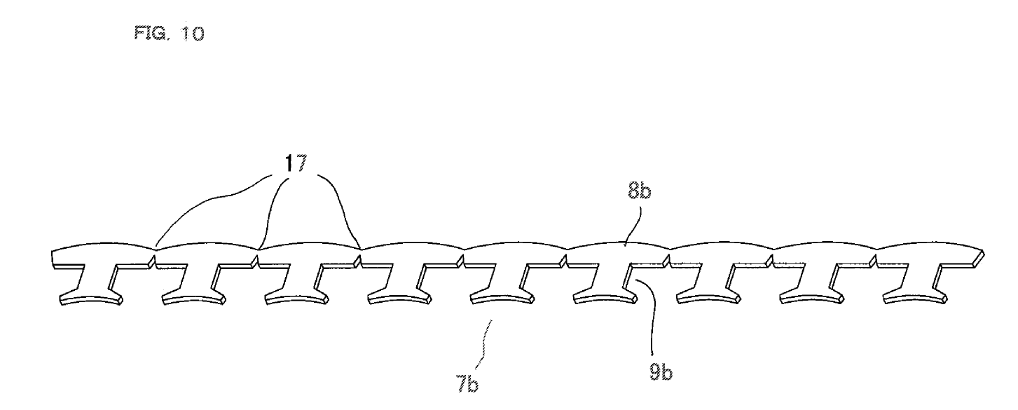

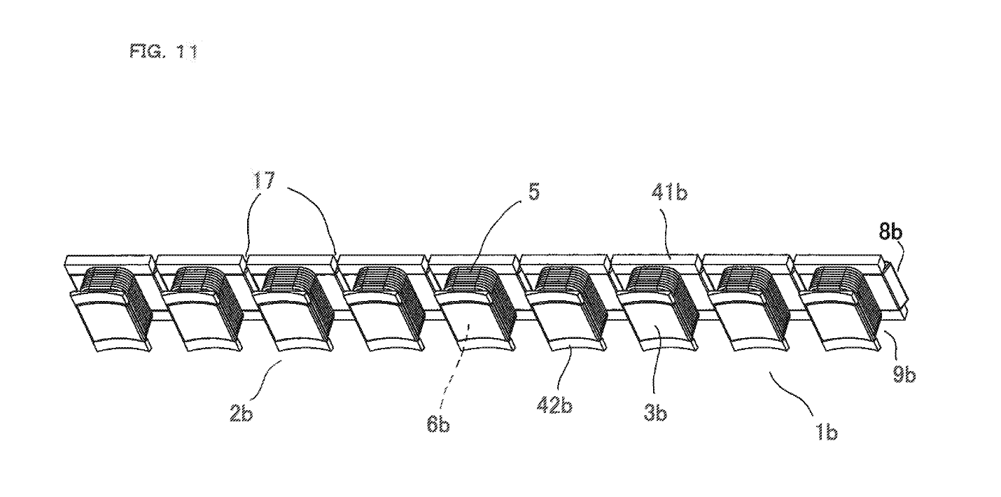

FIG. 10 is an oblique perspective view illustrating a core sheet in a stator of a rotary electric machine according to Embodiment 3 of the present invention, and FIG. 11 is an oblique perspective view illustrating a stator magnetic pole in the stator of the rotary electric machine according to Embodiment 3 of the present invention. In the above-described electric machine according to Embodiment 1, the core-sheet laminate 6 is configured by using the yoke portion 8 and the core sheets 7, having a near T-shape, which include the teeth portion 9 protruded from the yoke portion 8, whereas in the rotary electric machine according to Embodiment 3 as illustrated in FIG. 10, a core-sheet laminate 6b may be configured by using a plurality of yoke portions 8b connected via a bending portion 17, and core sheets 7b which includes a plurality of teeth portions 9b protruded in a direction at right angle from each of the yoke portions 8b.

As illustrated in FIG. 11, a coating film 3b made of an insulating paint is coated on whole surface of the core-sheet laminate 6b formed by laminating the core sheets 7b in a thickness direction of the core sheets 7, whereby a stator core 2b is formed. And then, a first bobbin 41b and a second bobbin 42b are mounted on both end surfaces in a core-sheet-laminate direction of the stator core 2b in a similar way according to Embodiment 1. Moreover, conductive wires are wound around the teeth portions 9b of the stator core 2b, and a stator coil 5 is mounted, whereby a stator magnetic pole 1b is configured.

The stator magnetic pole 1b illustrated in FIG. 11 is formed in a cylindrical shape by bending a bending portion 17, and fixed to a stator flame (not illustrated) or the like. Thereby, a stator f the rotary electric machine is formed.

In addition, as the above-described rotary electric machine according to Embodiment 2, it is suitable that the first bobbin 41b and the second bobbin 42b are mounted on the core-sheet laminate 6b, on which a coating film is not yet coated, so as to form the integrated component formed with the core-sheet laminate and the bobbins, and a coating film 3b is coated on whole surfaces of the integrated component, and then, the stator coil 5 is mounted.

The stator of the rotary electric machine according to Embodiment 3 can provide the same effect obtained in the stator of the above-described rotary electric machine according to Embodiment 1 or Embodiment 2.

### Embodiment 4

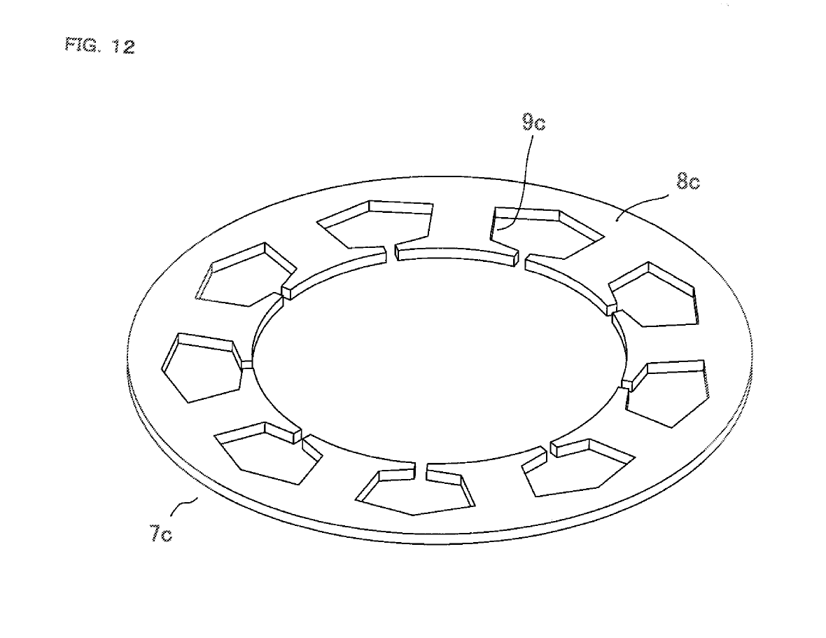

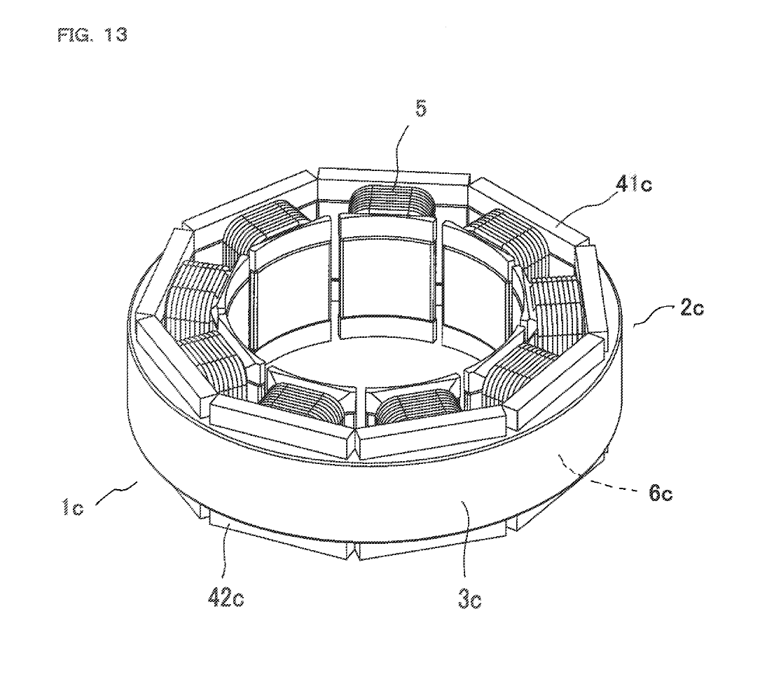

FIG. 12 is an oblique perspective view illustrating a core sheet in a stator of a rotary electric machine according to Embodiment 4 of the present invention, and FIG. 13 is an oblique perspective view illustrating a stator magnetic pole in the stator of the rotary electric machine according to Embodiment 4 of the present invention. In the rotary electric machine according to Embodiment 4 as illustrated in FIG. 12 and FIG. 13, a core-sheet laminate 6c is configured by laminating yoke portions 8c formed in an annular shape and core sheets 7c including a plurality of teeth portions 9c protrude from the yoke portions 8c to inside in a diameter direction of the yoke portions 8c.

A coating film 3b made of an insulating paint is coated on whole surface of the core-sheet laminate 6c formed by laminating the core sheets 7c in a thickness direction of the core sheets 7c, whereby a stator core 2c is formed. And then, a first bobbin 41c and a second bobbin 42c are mounted on both end surfaces in a core-sheet-laminate direction of the stator core 2c in a similar way according to Embodiment 1. Moreover, conductive wires are wound around the teeth portions 9c of the stator core 2c, and a stator coil 5 is mounted, whereby a stator magnetic pole 1c is configured.

The stator magnetic pole 1c is fixed to a stator flame (not illustrated) or the like. Thereby, a stator f the rotary electric machine is formed.

In addition, as the above-described rotary electric machine according to Embodiment 2, it is suitable that the first bobbin 41c and the second bobbin 42c are mounted on the core-sheet laminate 6c, on which a coating film is not yet coated, so as to form the integrated component formed with the core-sheet laminate and the bobbins, and a coating film 3c is coated on whole surfaces of the integrated component, and then, the stator coil 5 is mounted.

The stator of the rotary electric machine according to Embodiment 4 can provide the same effect obtained in the above-described stator of the rotary electric machine according to Embodiment 1 or Embodiment 2.

### INDUSTRIAL APPLICABILITY

The stator of the rotary electric machine and the manufacturing method for the stator of the rotary electric machine according to the present invention can be applied, for example, in a field of an on-vehicle rotary electric machine mounted on a vehicle, such as a car, or in the other field of a rotary electric machine.

1-15. (canceled)

16. A stator of a rotary electric machine, comprising:
a core-sheet laminate that is formed by laminating a plurality of core sheets made of metal plates;
a coating film that is made of an insulating paint coated on a surface of the core-sheet laminate;
a stator coil that is made of a conductive wire wound around the core-sheet laminate via the coating film; and
bobbins made of an insulating material, which are inserted between the coating film and the stator coil corresponding to only the predetermined part of the core-sheet laminate containing edge portions, and prevent the conductive wire of the stator coil from contacting to the coating film that is coated on edge portions of the core-sheet laminate, or relieve pressure caused by the contact.

17. A stator of the rotary electric machine according to claim 16, wherein the bobbins include a first bobbin that corresponds to a first surface of the core-sheet laminate so as to be mounted, and a second bobbin that corresponds to a second surface facing the first surface of the core-sheet laminate so as to be mounted.

18. A stator of the rotary electric machine according to claim 17, wherein the first surface is one end surface in a laminate direction of the plurality of core sheets in the core-sheet laminate, and the second surface is the other end surface in the laminate direction of the plurality of core sheets in the core-sheet laminate.

19. A stator of the rotary electric machine according to claim 17, wherein the first surface is one end surface that extends in a laminate direction of the plurality of core sheets in the core-sheet laminate, and the second surface is the other end surface that extends in the laminate direction of the plurality of core sheets in the core-sheet laminate.

20. A stator of a rotary electric machine, comprising:
a core-sheet laminate that is formed by laminating a plurality of core sheets made of metal plates;
bobbins, made of an insulating material, which are mounted on the core-sheet laminate in a state where the bobbins correspond to only the predetermined part of the core-sheet laminate containing edge portions;
a coating film, made of an insulating paint, which is coated on an outer surface, on which the bobbins are not mounted, of the core-sheet laminate, and on an outer surface of the bobbins; and
a stator coil that is made of a conductive wire wound around the core-sheet laminate and the bobbins via the coating film.

21. A stator of the rotary electric machine according to claim 20, wherein the bobbins include a first bobbin that corresponds to a first surface of the core-sheet laminate so as to be mounted, and a second bobbin that corresponds to a second surface facing the first surface of the core-sheet laminate so as to be mounted.

22. A stator of the rotary electric machine according to claim 21, wherein the first surface is one end surface in a laminate direction of the plurality of core sheets in the core-sheet laminate, and the second surface is the other end surface in the laminate direction of the plurality of core sheets in the core-sheet laminate.

23. A stator of the rotary electric machine according to claim 21, wherein the first surface is one end surface that extends in a laminate direction of the plurality of core sheets in the core-sheet laminate, and the second surface is the other end surface that extends in the laminate direction of the plurality of core sheets in the core-sheet laminate.

24. A stator of the rotary electric machine according to claim 16, wherein the bobbins are formed in such a way that at least a shape of the bobbin at the core-sheet laminate side is identical to a shape of a surface of the core-sheet laminate corresponding to the bobbin, or identical to a shape surrounding the surface.

25. A stator of the rotary electric machine according to claim 16, wherein the edge portions at the stator coil side in the bobbins is formed in a curved surface.

26. A stator of the rotary electric machine according to claim 16, wherein each of the plurality of core sheets includes a yoke portion and teeth portion that is protruded from the yoke portion.

27. A stator of the rotary electric machine according to claim 16, wherein the core sheets include a plurality of yoke portions connected to the core sheets via portions which can be bent, and a plurality of teeth portions which are respectively protruded from the plurality of yoke portions.

28. A stator of the rotary electric machine according to claim 16, wherein the core sheets include yoke portions having an annular shape, and a plurality of teeth portions which are protruded from the yoke portions in diameter directions of the yoke portions.

29. A stator of the rotary electric machine according to claim 16, wherein the stator coil is mounted on a portion corresponding to the teeth portions in the core-sheet laminate.

30. A stator of the rotary electric machine according to claim 16, wherein the core sheets are formed from a sheet made of a thin metal plate by using a press-cutting method, a wire-cutting method, or a laser-cutting method.

31. A stator of the rotary electric machine according to claim 16, wherein the coating film is formed by using an electrodeposition coating method, an electrostatic coating method, or a spray painting method.

32. A manufacturing method for a stator of a rotary electric machine, comprising:
a step of manufacturing a core-sheet laminate that is formed by laminating a plurality of core sheets made of metal plates;
a step of forming a coating film by coating an insulating paint on a surface of the core-sheet laminate;
a step of mounting bobbins made of an insulating material on a surface of the coating film that is coated on at least edge portions or portions neighboring the edge portions of the core-sheet laminate; and
a step of mounting a stator coil by winding a conductive wire around the core-sheet laminate via the coating film and the bobbins,
wherein the bobbins are mounted on the surface of the coating film in a state where the bobbins correspond to only the predetermined part of the core-sheet laminate containing edge portions.

33. A manufacturing method for a stator of a rotary electric machine, comprising:
a step of manufacturing a core-sheet laminate that is formed by laminating a plurality of core sheets made of metal plates;
a step of mounting bobbins made of an insulating material on the surface of the core-sheet laminate in a state where the bobbins correspond to only the predetermined part of the core-sheet laminate containing edge portions;
a step of forming a coating film by coating an insulating paint on a surface of the core-sheet laminate and a surface of the bobbins; and
a step of mounting a stator coil on the core-sheet laminate by winding a conductive wire around a surface of the coating film.
